(19) United States
(12) Patent Application Publication
(10) Pub. No.: US 2017/0344748 A1
(43) Pub. Date: Nov. 30, 2017

(54) Intelligent Secure Social Media Based Event Management System

(71) Applicant: Umm-Al-Qura University, MAKKAH (SA)

(72) Inventors: Sohaib Ghani, MAKKAH (SA); OSAMA HUSSAIN, MAKKAH (SA); MOMEN ZAKARIA, MAKKAH (SA); Mohammed Mokbel, MAKKAH (SA)

(73) Assignee: Umm-Al-Qura University, MAKKAH (SA)

(21) Appl. No.: 15/169,185

(22) Filed: May 31, 2016

(51) Int. Cl. G06F 21/60; H04L 29/06; H04L 12/58; H04L 12/26; G06Q 50/00; H04L 29/08; G06F 17/30

(52) U.S. Cl. CPC G06F 21/604; H04L 67/306; H04L 67/10; H04L 63/10; G06F 17/30557; H04L 43/10; H04L 43/06; G06Q 50/01; H04L 51/32

(57) ABSTRACT

An intelligent system and method for gathering social network data for an event, moderate the data, and display it to people along with analytics. The system helps event managers to see all the details posted about the event and they can control what to show to the general public. It also helps people to see what is being posted about the event and also encourages them to post. Additionally, the back end intelligence can scan through the posts and group them according to common thread and allow those to be backed up in redundant servers for forensic analysis.

### FIELD OF TECHNOLOGY

This disclosure relates to the comprehensive social media based intelligent event management system that provides comprehensive cohesive platform to obtain real-time feedback of patrons through social media applications

This disclosure relates generally to a field of a method and system for event management. More particularly, it relates to an intelligent system that provides real-time access to user opinions and chats in various forums to event hosts, local security, law enforcement and general public

This disclosure also relates to a comprehensive methodology of monitoring an event related social media conversations for intelligent analysis on occurrence of an untoward situation. More particularly, it relates to an intelligence based back end cloud based expert system that analyzes the data and organizes in a way that is directly useful for law enforcement. This disclosure also relates to the expert system providing forensic analysis using the knowledge base to the expert investigators and analysts for investigation purposes

This disclosure relates to a system that can be used by local security to monitor real-time based on social media conversations, any trouble areas. The chatter can be proactively used for prevention of untoward incidents

This disclosure relates to a cohesive social media platform for people interested in a particular event for providing and conversing during the event actively or commenting offline not being present in the event venue. More particularly, this disclosure relates to a comprehensive platform that provides public a single place to access all the well-known social media applications and converse using voice, video and data.

### BACKGROUND

Social networks such as Facebook and Twitter are now becoming part and parcel of people's daily life. Since their inception, social networks have been transforming the way people express opinions, react to events, and share their ideas. Social networks have become very popular in the last few years.

For twitter alone, 500+ Million tweets are posted by 255+ Million active users every day. People generally use them to post their daily life events and also do check-ins of the visited places.

Whenever people visit any event, they want to see its details on social networks. They want to see what other people are posting about it. Based on it they may also post about it or share other users posts. However, to extract this information they have to access the social network and search the details of the event. It will be useful if for any event they get this information automatically filtered for the event and displayed on the big screen.

Nowadays, event managers also want to organize all the details publishing about the event on social network. They want to show analytics and stats about it in terms of nice visualizations. They also cannot directly show the live data as it may contain inappropriate contents or spam posts. They want to moderate the data and display only relative and interesting information.

Event hosts do not have a system where they can provide a common access to the patrons to login and use a variety of social media application while allowing them to monitor the chatter. This enables the event hosts to fine tune their event to cater the needs of their patron based on the live feedback in the social media. Intelligent system that can filter and group the common thread that is event specific is not available today.

General public do not have a common system that focusses on an event and provides a mechanism to access multiple social media applications allowing their chats to be posted in a large screen.

Local security working at the event does not have a common system that allows them to monitor the chats relevant to the event to proactively prepare for any untoward incident. It also allows local security to be prepared and conduct their duties smoothly and seamlessly.

Law enforcement monitoring actively do not have an event specific intelligence to react when an incident occurs. There is no system available which can immediately filter the event specific information for forensic analysis.

We propose an intelligent system to gather social network data for an event, moderate the data, and finally display it to people along with analytics. In this way, it will help event managers to see all the details posted about the event and they can control what to show to the general public. It will also help people to see what is being posted about the event and will also encourage them to post as their post will be displayed on big screen and will be seen by many people. Additionally, the back end intelligence can scan through the posts and group them according to common thread and allow those to be backed up in redundant servers for forensic analysis.

With this system an event manager can collect details of an event, moderate the data to be presented to people, and shows the data along with analytics. It will be useful and interesting for the public attending the event. They will see what and who are posting about the event. It will also motivate the other people attending the event to post. The event manager can also post the link of the presentation view page to event website or social network page so that people not attending the event can also see what is happening in the event.

In the proposed methodology, we show how such an intelligent system can be created where an event can be managed while providing a platform for event hosts and general public. In addition the system has a dual purpose to engage local security and law enforcement for monitoring, prevention and forensic analysis purposes.

### SUMMARY

Several embodiments for a system and method for intelligent secure social media based event management are disclosed.

Several embodiments for a backend cloud based expert system and method for intelligent expert analysis system, within the proposed intelligent event management system, to centrally analyze the data captured through social media from people who are attending an event and those who have interest in the event, for proper execution and forensic investigation are disclosed.

In one embodiment, the backend cloud based intelligent event management expert system captures data from social media conversations including photographs, voice chats, video chats, and all forms of data, conducted by people attending an event, specific to the event and its related subevents and areas.

In one embodiment, the proposed intelligent event management system is fault-tolerant. The system has multiple instances running as redundant systems for high availability. The knowledgebase is also fault-tolerant with multiple copies being backed up either in premises or over cloud in remote locations.

In one embodiment, the backend cloud based intelligent event management expert system provides an interface for the local security to monitor the conversation specific to the event and its related subevents and areas.

In one embodiment, the backend cloud based intelligent event management expert system provides an interface for the law enforcement to seamlessly monitor the conversation related to the event and subevents from people attending or those interested in the events. The law enforcement monitors the local security handling of the event as well.

In one embodiment, the backend cloud based intelligent event management expert system provides data analytics function for the event based conversations.

Several embodiments for a backend cloud based intelligent event management expert system and method for intelligent event management system to analyze the captured real-time knowledgebase to various forensic analysts are disclosed.

In one embodiment, the backend cloud based intelligent event management expert system provides forensic analysis capability to the law enforcement and investigation agencies to conduct analysis using tools on the captured data is disclosed.

In one embodiment, the cloud based intelligent event management system provides data gathering capabilities to obtain real-time conversations in all formats from various social media and log into the redundant database.

In one embodiment, the cloud based intelligent event management system provides user interfaces specific for analysis to conduct investigation both real-time and non-real-time on data captured during an event that has occurred in the past, presently ongoing or going to occur in future.

In one embodiment, the cloud based intelligent event management system provides security and law enforcement agencies to conduct “what if” scenarios by perturbing the data based on past event management data.

Several embodiments for a cloud based intelligent event management system supporting various social media applications that communicate either through or a combination of pictures, video and data are disclosed.

In one embodiment, the cloud based intelligent event management system supports social media applications that enable conversations and sharing between users who use pictures alone to share information on an event.

In one embodiment, the cloud based intelligent event management system supports social media applications that enable conversations and sharing between users who use all forms of data, including chats, emoticons, file transfers and web addresses, to share information on an event, subevents and surrounding areas.

In one embodiment, the cloud based intelligent event management system supports social media applications that enable voice conversations between two users, or a multicast between a group of users, or a broadcast to a whole group regarding an event, subevent and surrounding areas.

In one embodiment, the cloud based intelligent event management system supports social media applications that enable conversations using multiple forms, namely more than one form, as pictures, voice, video and data.

Several embodiments for a cloud based intelligent event management system supporting various social media applications individually are disclosed. Several embodiments of a cloud based intelligent event management system that support various agencies that have interest in hosting, participating, conducting and maintaining an event are disclosed.

In one embodiment, the cloud based intelligent event management system supports local security agencies to login to the system with special view and customize the views that helps them monitor for security purposes.

In one embodiment, the cloud based intelligent event management system supports the emergency preparedness of local security agencies based on the conversation from various social media applications over an event.

In one embodiment, the cloud based intelligent event management system supports the disaster recovery of an event in case of a situation for local security agencies based on social media input.

In one embodiment, the cloud based intelligent event management system supports the local security to address the event attendees to follow certain rules of engagement during the event for smooth functioning of an event.

In one embodiment, the cloud based intelligent event management system supports the local security to address the event attendees to emergency preparedness processes and procedures. For example, local security can show all the emergency exits in a map at an event venue.

In one embodiment, the cloud based intelligent event management system supports the local security to coordinate disaster recovery processes and procedures to the participants of events over social media.

In one embodiment, the cloud based intelligent event management system supports the law enforcement agencies to coordinate their effort through local security or directly to the event participants over social media.

In one embodiment, the cloud based intelligent event management system supports the law enforcement agencies to monitor and prepare for any kind of situation based on the conversations in social media.

In one embodiment, the cloud based intelligent event management system supports event managers to conduct the event smoothly and coordinate all event information through social media to the attendees.

In one embodiment, the cloud based intelligent event management system supports event managers to monitor the event over social media and learn the need of the attendees and cater to those needs.

In one embodiment, the cloud based intelligent event management system supports event management to customize filters so relevant information are posted to the event attendees.

In one embodiment, the cloud based intelligent event management system supports event management to display a consolidated message board for all attendees to monitor.

In one embodiment, the cloud based intelligent event management system supports event managers to collect trends and intelligence through social media on the pulse of the participants and those that are not attending but have an interest in the event.

In one embodiment, the cloud based intelligent event management system supports event managers to customize specific to the events the views of various social media so the input is available in a single place of choice and the output is collectively sent to a group of social media applications.

In one embodiment, the cloud based intelligent event management system supports event attendees and general public to relay their opinion through a group of social media application related to the event. In one embodiment, the cloud based intelligent event management system supports event attendees to converse with like-minded and those interested in a specific event in a single place, who are otherwise scattered over in various social media applications.

In one embodiment, the cloud based intelligent event management system supports event attendees to share through pictures, voice, video and data over social media applications related to events. Several embodiments of a cloud based intelligent event management system that supports various output display technologies for viewing the event related conversations are disclosed.

In one embodiment, the cloud based intelligent event management system supports large display screens that event attendees, managers and local security can access and relay information to each other.

In one embodiment, the cloud based intelligent event management system supports display of consolidated social media conversations in a customized view in all form factors of output displays such as desktop, laptops, tablets, smart devices, all forms of screens and phones

Several embodiments of a cloud based intelligent event management system user interfaces with various levels of access control are disclosed.

In one embodiment, the cloud based intelligent event management system supports general user access to event attendees that is customizable for conducting conversations of pictures, voice, video and data over one or multiple social media applications.

In one embodiment, the cloud based intelligent event management system supports event management user access to event managers to filter and customize social media conversations and group them.

In one embodiment, the cloud based intelligent event management system supports local security access to customize access and views to monitor conversation, prepare for emergency, relay emergency preparedness procedures and rules, and handle recovery mechanisms.

In one embodiment, the cloud based intelligent event management system supports law enforcement access to customize access and view to handle enforcement for smooth functioning of event, coordinate emergency preparedness and disaster recovery with other agencies and event attendees. In one embodiment, the cloud based intelligent event management system supports law enforcement access to conduct investigation and analysis over real-time data or forensic data.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates the examples of popular social media applications

FIG. 2 shows the social media application distribution in terms of still photographs, video and data

FIG. 3 illustrates the unfiltered day to day social media connectivity

FIG. 4 illustrates the connectivity of the proposed intelligent event management system to users, displays and social media applications

FIG. 5 shows the high level connectivity between devices and the proposed intelligent event management system

FIG. 6 illustrates the different applications of the proposed intelligent event management system

FIG. 7 illustrates the system components of the intelligent event management system

FIG. 8 depicts the server components of the proposed intelligent event management system

FIG. 9 depicts the client components of the proposed intelligent event management system

FIG. 10 shows the control and data flow diagram of various functionalities

FIG. 11 shows the user interface dependencies between the users and back end functions

FIG. 12 illustrates the user interface message flow between modules

FIG. 13 illustrates the client interface for various users

FIG. 14 shows the customization of the social media application for users

FIG. 15 illustrates the profile management within the proposed intelligent event management system

FIG. 16 shows the visualization example in a giant display

FIG. 17 illustrates the user monitoring capability within the proposed intelligent event management system

FIG. 18 illustrates the analytics portion for various social media application

Other features of the present embodiments will be apparent from the accompanying drawings and from the detailed description that follows.

### DETAILED DESCRIPTION

Several method, process and systems for intelligent cloud based secure social media based event management system are disclosed. Although the present embodiments have been described with reference to specific example embodiments, it will be evident that various modifications and changes may be made to these embodiments without departing from the broader spirit and scope of the various embodiments.

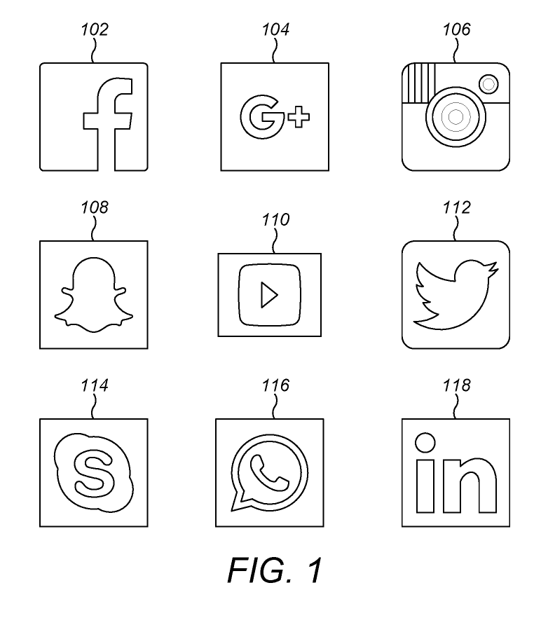

FIG. 1 is an illustration of the various popular social media examples today. The intelligent secure social media based event management system supports social media applications and is not restricted to those available today. Without loss of generality, it supports and the proposed methodology could work with the popular social media applications available today such as Facebook 102, Google plus 104, Instagram 106, Snapchat 108, YouTube 110, Twitter 112, Skype 114, WhatsApp 116 and Linkedin 118.

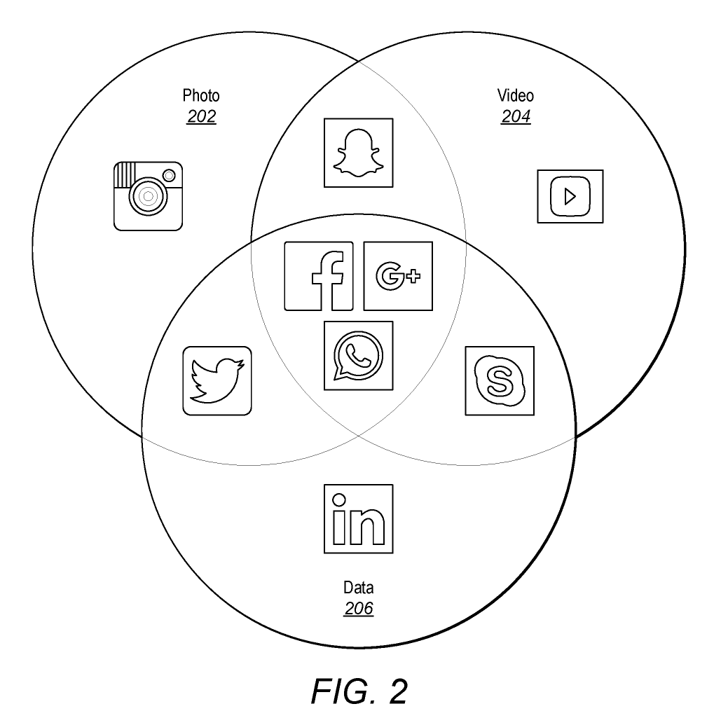

FIG. 2 illustrates the social media application distribution. Popular distribution of social media conversations includes pictures, 202, video 204 and data 206. For example, Instagram 106 predominantly uses pictures to share between users, while snapchat 108 uses pictures and video. YouTube 110 uses video alone for sharing, while Skype 114 uses video and data for sharing. Linkedin 118 uses data alone for sharing while Twitter 112 uses both short data forms and pictures to be shared. Some applications such as Facebook 102, Google plus 104 and WhatsApp 116 allow conversations that include pictures, voice, video and data.

FIG. 1 and FIG. 2 illustrates together the arrangement of the social media applications over the gamut of pictures, voice and video.

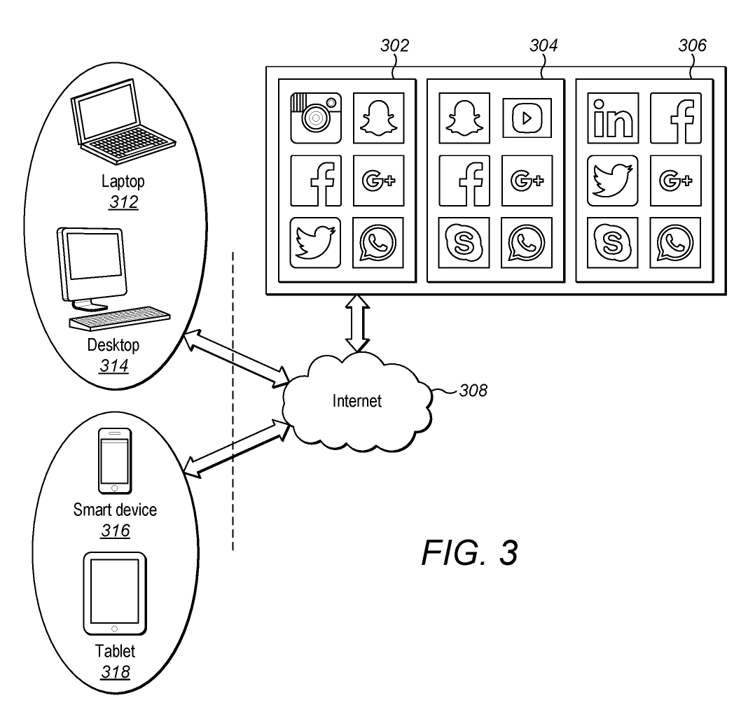

FIG. 3 illustrates the unfiltered social media connectivity possible today for general public. The group of social media applications is available over Internet 308 to be accessed by general public through their popular devices such as laptops 312, desktops 314, smart devices 316 and tablets 318. The social media applications provide picture sharing 302, voice and video chats 304 and data sharing 306.

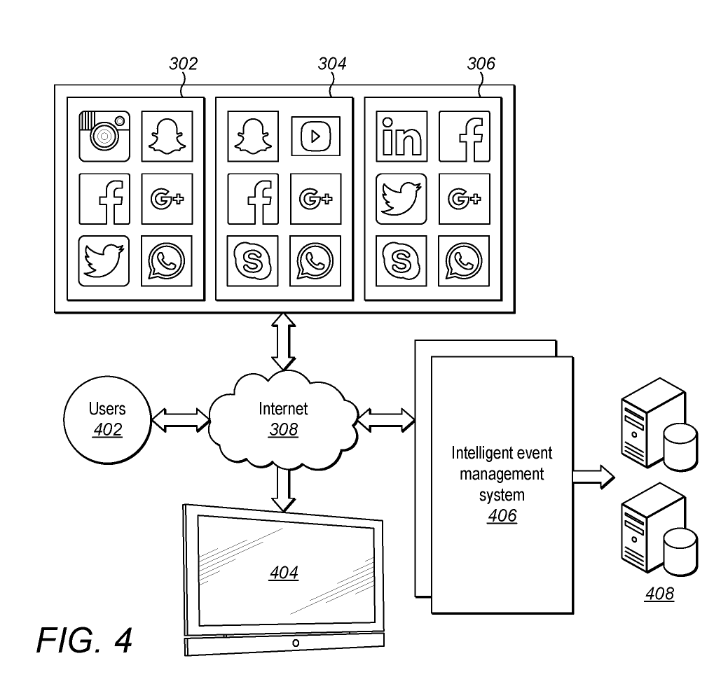

FIG. 4 illustrates the proposed intelligent event management system 406 high level network architecture. The proposed system 406 is fault tolerant through redundancy as can be seen from the overlapping system picture. The proposed system 406 has access to redundant knowledge base 408 where the data is stored for conducting conversations, real-time analysis and forensic analysis. The system is cloud based and has access over Internet 308 to users 402. The users 402 can access various social media applications to conduct conversations by sharing pictures 302, voice and video 304 and data 306. The event managers display the event related conversations in a single large display 404 and local displays such as laptops 312, desktops 314, smart devices 316 and tablets 318.

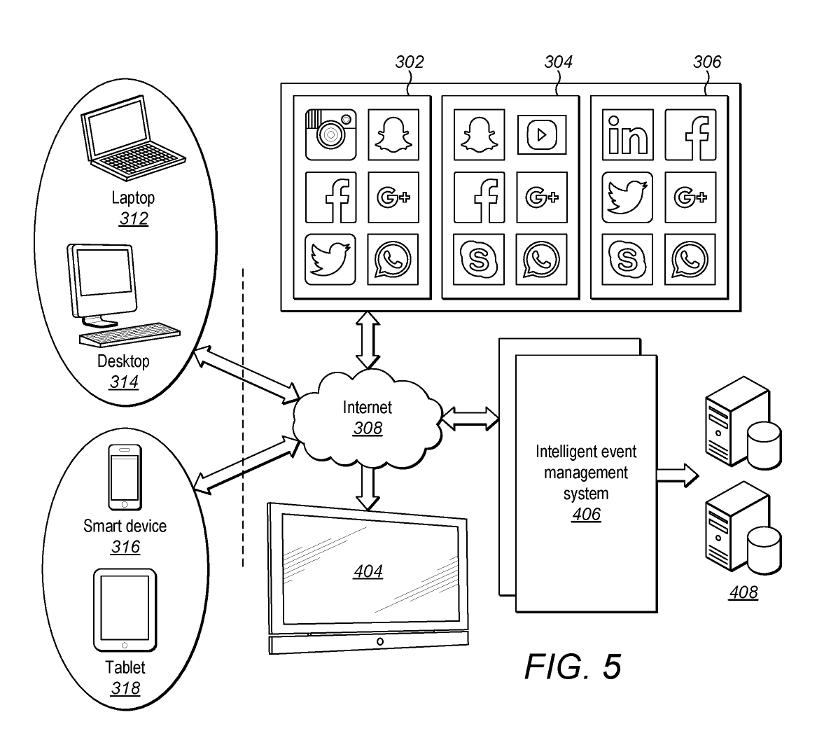

FIG. 5 illustrates the high level network architecture of intelligent connectivity. The proposed system 406 provides users access to social media applications 302, 304, 306 connecting them to the social media world through large displays 404, laptops 312, desktops 314, smart devices 316 and tablets 318

FIGS. 4 and 5 together illustrate the connectivity architecture, between the proposed system 406, users 402, social media applications 302, 304, 306 and the access tools 404.

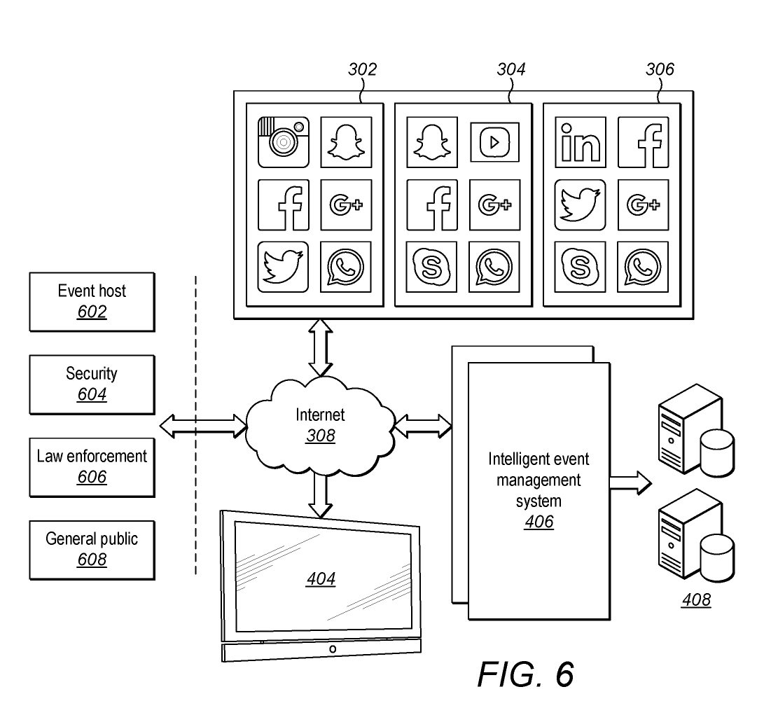

FIG. 6 illustrates the variety of users that the proposed system 406 supports. The system supports event hosts 602 to manage the event, keep the attendees informed, provide attendees a common platform to relay their opinions and facilitate the smooth functioning of the event. Event hosts 602 also display an abridged filtered version of conversation in the display 404 for all patrons to view. This helps more attendees to participate and relay their views thus helping event hosts to fine-tune the functioning to address the patrons' needs. The system supports local security 604 to conduct the event in a secure fashion. The local security 604 relays emergency procedures and signs for orderly conduct of the event. The local security 604 monitors the event continuously to proactively avoid any untoward incident. The proposed system 406 supports law enforcement agencies 606 to monitor the event over social media “chatter” from those attending and those who are interested in the event over a period of time. The agency 606 conducts real-time analysis and forensic analysis based on data in 408. The agency 606 coordinates the activities during disaster recovery and uses the display 404 to relay information to general public and event hosts. The proposed system 406 supports general public access to the social media applications 302, 304, 306 over Internet 308. The system 406 provides a consolidated platform for general public to get information from various people interested in the event, either participating or not. It is difficult for attendees to go through all social media applications and gather conversations related to an event, and our proposed system 406 provides that view.

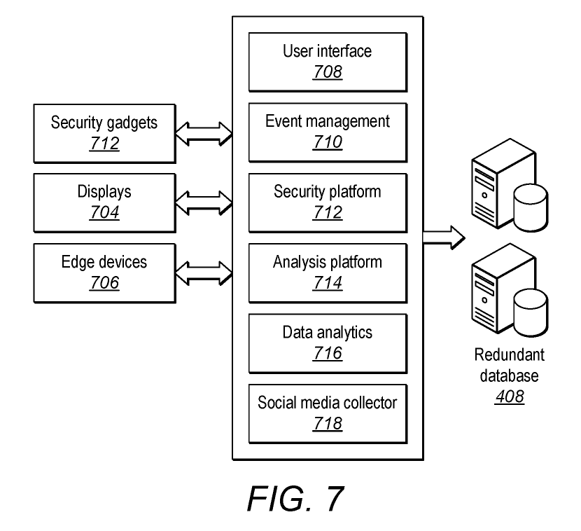

FIG. 7 illustrates the proposed intelligent event management system 406 components. The system 406 has User Interface 708, Event management 710, Security platform 712, Analysis platform 714, data analysis 716 and social media collector 718 components. The system 406 provides connectivity to uses through security gadgets 702, displays 704 and edge devices 706. The user interface 708 provides access control to general public, event hosts, security and law enforcement. Event management 710 provides functionality for consolidated access to social media applications for a particular customized event. Security platform 712 provides interface to local security to monitor and relay messages for smooth functioning of the event and messages related to emergency preparedness. Analysis platform 714 provides the functionality for law enforcement to conduct both real-time and forensic analysis based on social media conversations collected in redundant knowledgebase 408. Data analytics 716 provides the functionality for event management and general public to view various performance graphs and analytics related to event encouraging participation from various attendees to post their views. The social media collector 718 provides the access to multiple social media applications and consolidates the views on a user basis, geographical basis, gender basis and other customizable parameters.

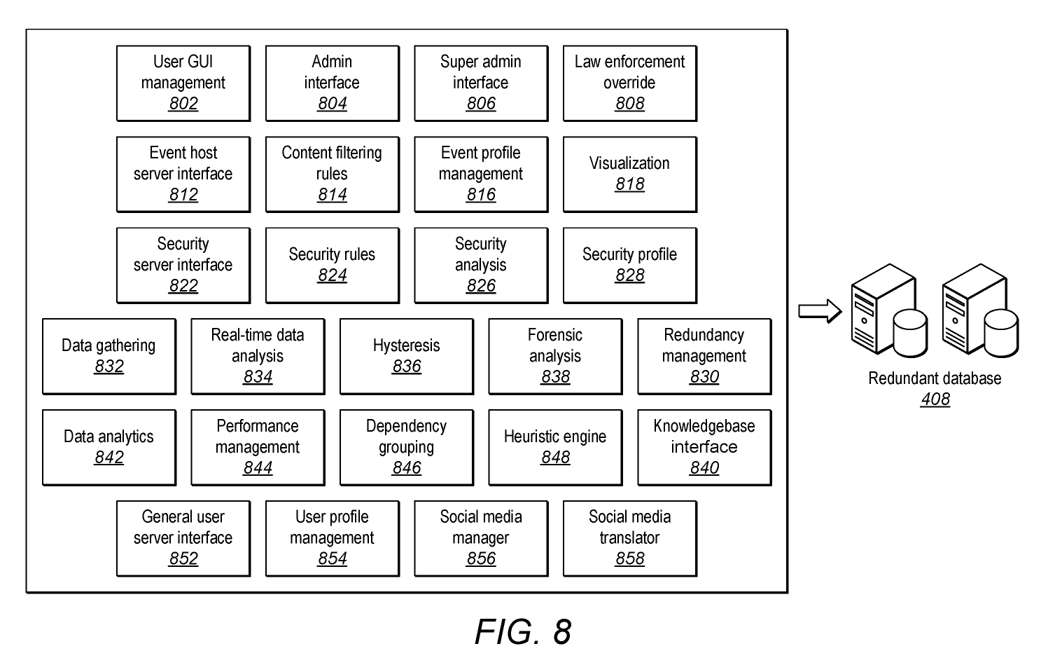

FIG. 8 illustrates the proposed intelligent event management system 406 cloud based server components. The subcomponents cover all the system components in FIG. 7. The User Interface 708 is handled by the User GUI management 802, Admin interfaces 804, and Super Admin interface 806 and Law enforcement override 808. The User GUI management 802 provides the functionality of configuring and customizing the Graphical User Interface (GUI) of general public access and event management access. Admin Interface 804 provides the administrator of the proposed system special access to handle event related configuration changes. Super Admin Interface 806 provides the functionality to the administration managers to override the admin configurations and provide special privileges to change configurations on a need basis. The Law enforcement override 808 provides the functionality to law enforcement during a situation or after to conduct real-time or forensic analysis based on data collected in the redundant knowledgebase 408.

In FIG. 8, the Event management 710 component has four subcomponents namely Event host server interface 812, Content filtering rules 814, Event profile management 816 and Visualization 818. These subcomponents are not directly available for Event hosts but can be manipulated through the user interface. The Event host server interface 812 provides the interface to the server database. Content filtering 814 allows filtering rules to be defined by the event managers so that postings from attendees and well-wishers that are inappropriate are filtered before being publicly displayed. The filtering rules can be set through configuration management interface. Event profile management 816 subcomponent provides the event managers to set profiles based on interest, gender, age, and various other profiles. These profiles help the managers target their information to correct audience and allows gathering analytics as well. Visualization 818 subcomponent provides the display functionality at the event location for the attendees so they can check their messages about the event in addition to security messages.

In FIG. 8, Security platform 712 has four subcomponents namely, the security server interface 822, security rules 824, security analysis 826, and security profile 828. The security server interface 822 subcomponent provides the unique API interface to the security server. Security rules 824 subcomponent allows the security configuration to input security related rules to get targeted information on the conversations. For example, local security can configure a trigger for “bomb” and other words to be flagged in conversation. Security profile subcomponent 828 provides the social media conversation information based on profiles. This allows security personnel to target a specific user names and follow their conversation.

In FIG. 8, Analysis platform 714 has five subcomponents, namely, Data gathering 832, Real-time data analysis 834, Hysteresis 836, Forensic analysis 838 and Redundancy management 830. Data gathering 832 subcomponent allows the integration of law enforcement requirement to gather social media data for a period of time over a profile and record for analysis. Real-time data analysis 834 subcomponent provides the analytical method capability to slice and dice the data as it emerges in the social media. The subcomponent correlates data from various social media applications over real-time and brings out a cohesive thread of information. The hysteresis 836 subcomponent uses intelligence techniques to analyze the real-time and stored data over a period of time to see if there is transience in a behavior or is a sustained problem area. Forensic analysis 838 subcomponent provides the important functionality of providing forensic analysis using stored data in redundant knowledgebase. This technique can be used by law enforcement agencies to analyze data after an event occurs for investigation purposes. Redundancy management 830 subcomponent provides the important functionality of managing multiple copies of knowledge base 408 running in the system. The subcomponent makes sure that the database is stable.

In FIG. 8, Data analytics 716 component has five subcomponents namely, data analytics 842, performance management 844, dependency grouping 846, heuristic engine 848 and knowledgebase interface 840. These subcomponents are used for intelligent analysis of data and for monitoring the performance and collecting analytics. The data analytics subcomponent 842 provides the important functionality of analytics that the event managers have requested. Performance management subcomponent 844 provides the functionality to display in graphical method or table the performance of the social media application, system and the user. Dependency grouping subcomponent 846 provides the important grouping of various social media to be targeted as a set. The user groups with common users in various social media are created. The heuristic engine 848 has intelligence algorithm based on fuzzy logic that automatically fine tunes the system to cater towards areas that the users require. For example, if the time of day in an event is close to noon, the heuristic engine 848 devices rules where advertisement to neighboring restaurants are displayed suggesting lunch availability. The display management using heuristic engine 848 is crucial for user attention and revenue generation. The knowledgebase interface 840 subcomponent provides the method to access the knowledgebase.

In FIG. 8, Social media collector component 718 has four subcomponents, namely General user server interface 852, user profile management 854, social media manager 856 and social media translator 858. The general user server interface 852 provides the general user some of the unique functionality to connect other users. User profile management 854 subcomponent provides the users to manage their social media profiles. For example, some users may be interested only in a few particular social media application. Social media manager subcomponent 856 groups the user profiles and manages the social media application in its totality. Social media translator subcomponent 858 provides the translation function for various languages so that display can be in a common language for event attendees.

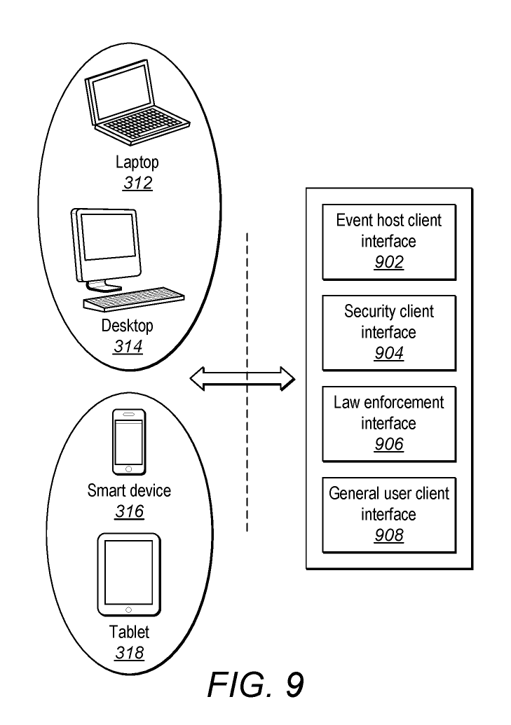

FIG. 9 illustrates the intelligent event management client components. The components are event host client interface 902, security client interface 904, law enforcement interface 906 and general user client interface 908. All the four clients provide a unique configuration window to their particular clients. The client has a back end server connection to access the server capabilities.

FIGS. 8 and 9 together illustrate the client and server components of the intelligent event management system.

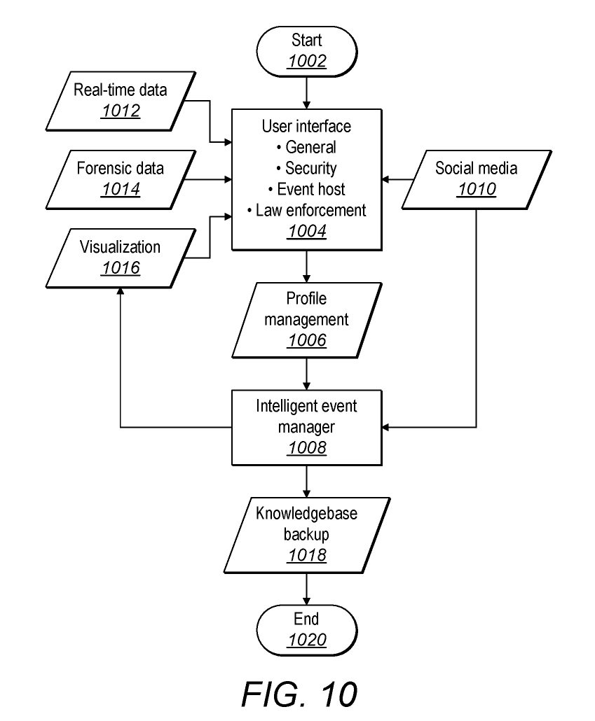

FIG. 10 illustrates the control and data flow of the messages through the intelligent system. The user interfaces 1004 are the starting point for general users, security, event host and the law enforcement. In addition, the security and law enforcement have access to real-time data through interfaces 1012 and forensic data 1014 through interfaces to redundant knowledge base 408. The four categories configure their priorities into the system through user interface 1004. The interface allows the category of users to configure profiles. The profiles are managed in profile management 1006. The Intelligent event manager 1008 uses the profile setting to operate its engine of configuring the set social media applications, collecting data, analytics for the profiles selected and display mechanisms. The event manager provides input to visualization 1016 for display purposes. The intelligent event manager also logs the social media information into knowledgebase with multiple copies for redundant purposes 1018.

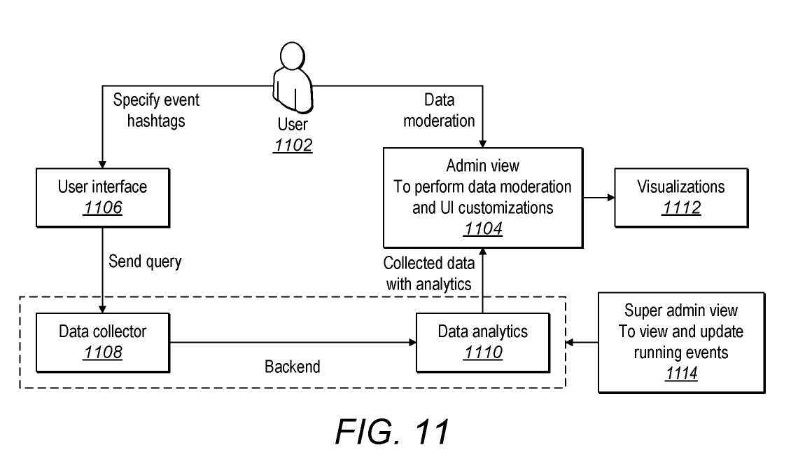

FIG. 11 illustrates the user interface dependencies. The four categories have general user interface 1106 provided with user name and password to access the back end system. The administrator of the intelligent event manager has a special admin view 1104 to perform data moderation and user interface customizations at programming level. The admin can create various templates for visualizations 1112. In addition, there is a super admin view 1114 that is for admin managers of the event management system to view and update running events real-time. They have access to the back end system to talk to data collector 1108 and data analytics 1110. The super admin view, for the system organizer, is to track multiple running events including functionality to do the following:
Track current running events over our system with infographics.
Ability to terminate any running event from the system.
Handle removing of idle event.

This view gives control to system administrator to keep track of all the events. He can delete any idle event or limit certain users in case of lots of events already running on the system server.

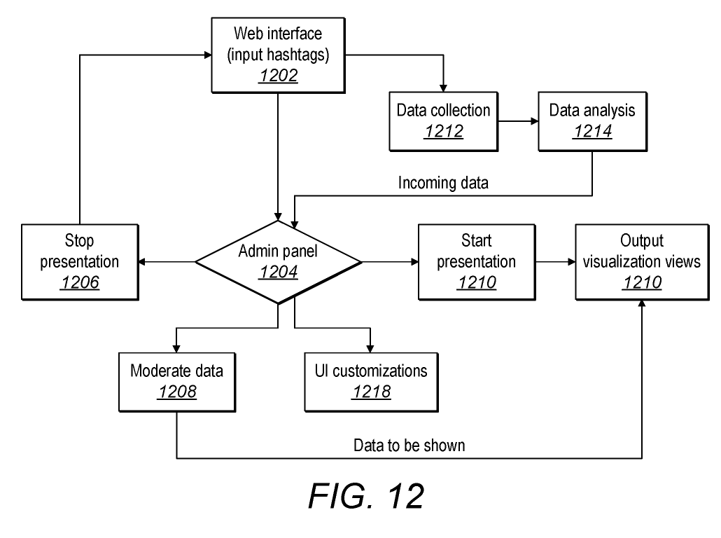

FIG. 12 illustrates the user interface flow chart and visualization process. The admin panel 1204 can start a presentation 1210 or stop a presentation 1206 in the display based on the filters. If the data filtering is properly done the moderated data 1208 can be shown in visualization display 1216. If stopped 1206 due to being inappropriate, the data is collected 1212 and logged for further analysis 1214. Meanwhile, user configuration can customize user interface 1218 through configuration mechanism as discussed earlier.

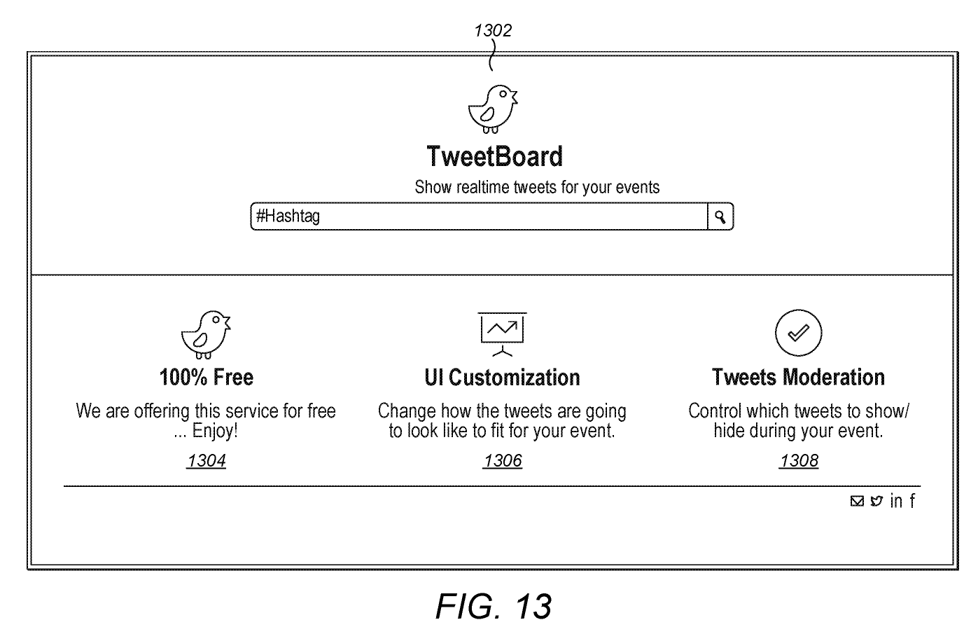

FIG. 13 illustrates the front end client interface that has a banner 1302. The illustration shows Tweetboard 1302 but without loss of generality, it can be customized. The user or event manager first accesses the main interface over the web and input the hashtags of the events through customization 1306. The manager will also choose different social networks (Facebook, Twitter, Instagram, etc.) from which to collect data 1308. The manager can choose either one or multiple networks based on the need.

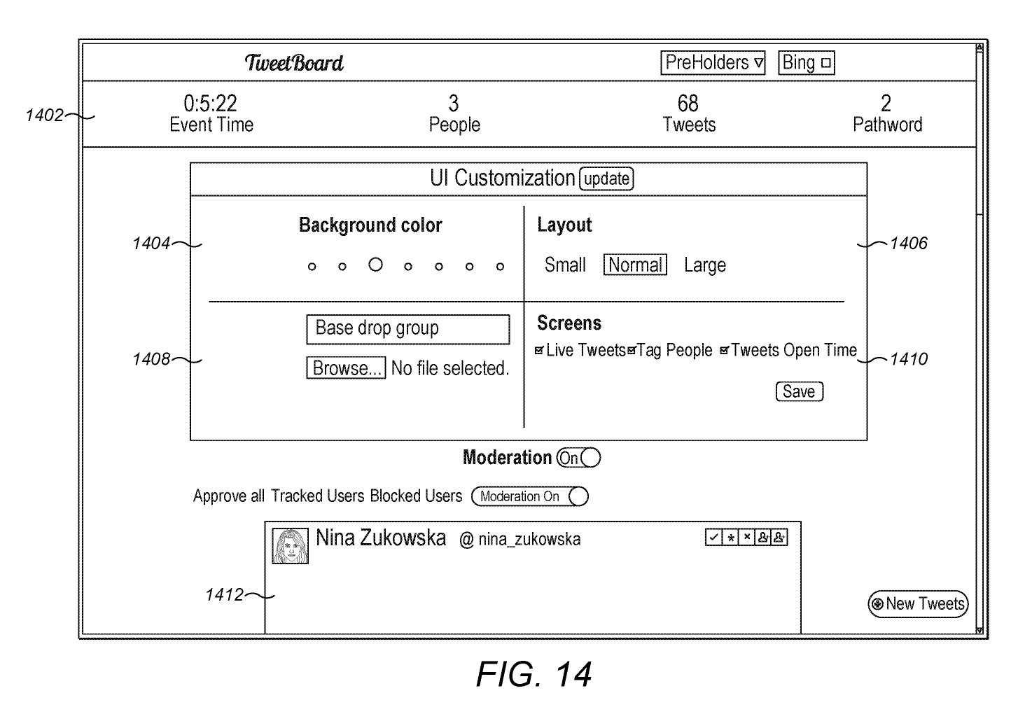

FIG. 14 illustrates the customization of the account in terms of color 1404, layout 1406, screens 1410 and banner 1402. The messages can also be displayed as per subscribed format 1412. Admin view will allow the intelligent event manager to moderate the data and do various customizations. The event manager will open the presentation views from this admin page. The event manager can also customize the presentation views on this page such as size of the views, background color, putting brand logo, and choose what views to display. The configuration query is send to the back-end intelligent event manager 406 which will start collecting data for the hashtags. The back-end intelligent event manager 406 will run crawlers to collect the data. It will also calculate stats and analytics and send the data back to the front end admin page for the event manager to moderate. The back-end intelligent event management system can handle many concurrent events. It will collect data for each event and send it back to its admin page. It will also collect data from multiple networks (Facebook, Twitter, Instagram, etc.) depending upon managers.

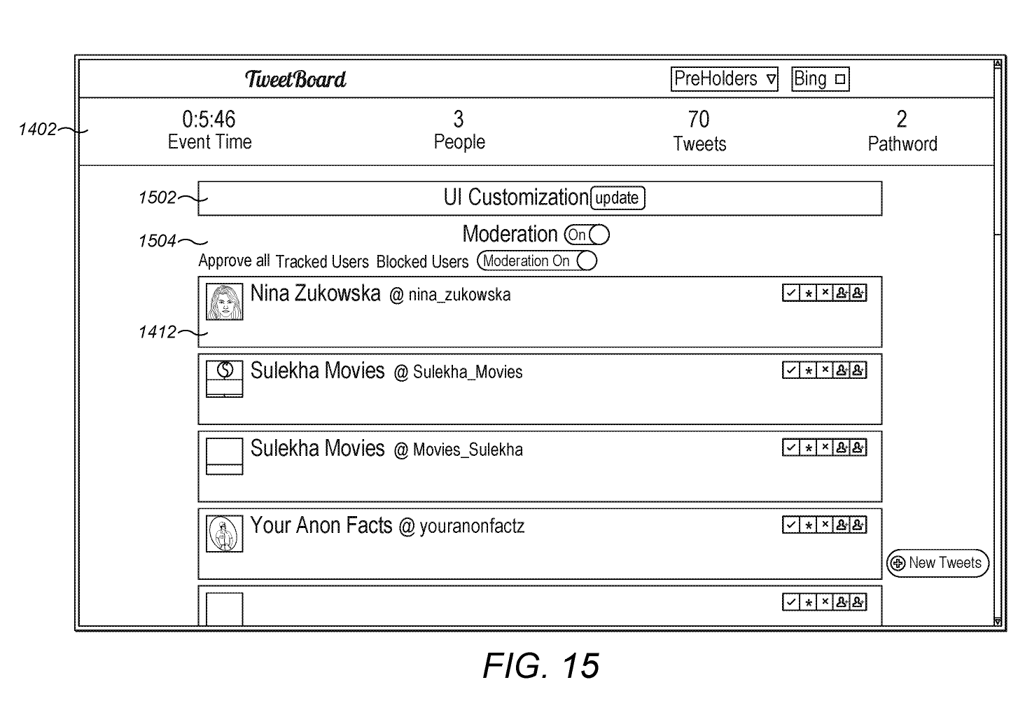

FIG. 15 illustrates the profile management where the User interface customization 1502, moderation 1504, and message display as per configuration 1412 are done. The manager can perform following functions in admin view namely:
Disable/Enable the retweets to be shown.
Disable/Enable Moderation (In disable moderation case all the data will be displayed in presentation views).
Approve all data.
Add trusted users (for trusted users all the posts will go to presentation view without moderation),
Add users to blocked list (blocked users posts will be automatically removed).
Star a post to make it appear on the presentation view instantly (otherwise the approved tweets will go in the queue and will displayed accordingly)
See updated event information over time (number of Tweets, number of Retweets, time)

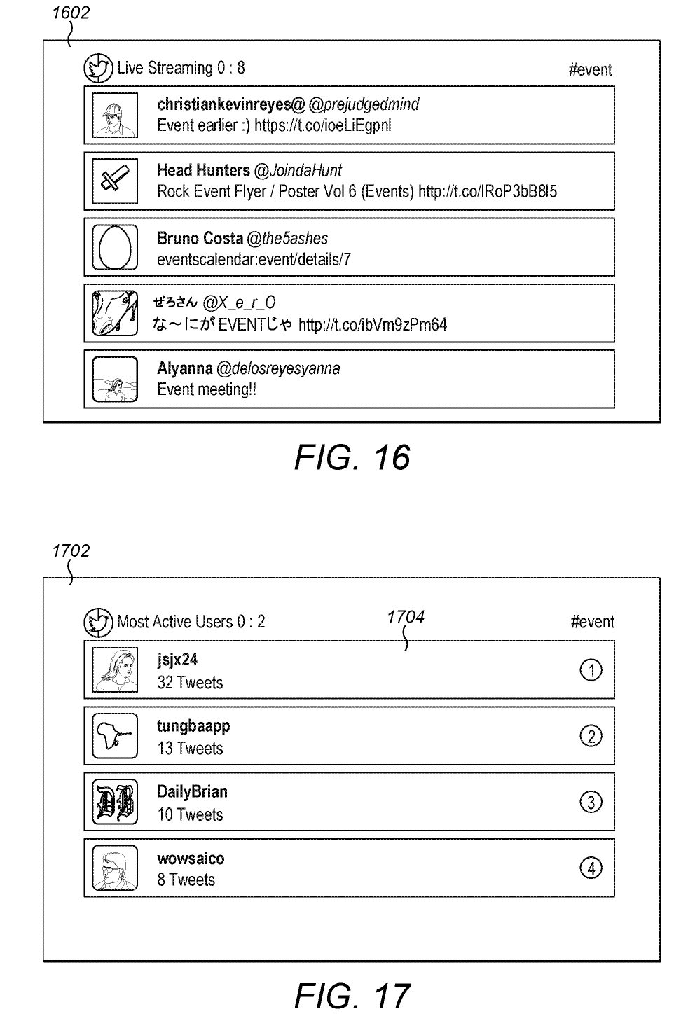

FIG. 16 illustrates the visualization view of the display. The display clearly shows live streaming 1602 notification and the messages that are live 1604. The original text or image is posted clearly for all attendees to see. The event manager can control the display time of each view in the administration page. The illustration shows various messages that are worthy of display as per administrator filtering constraints.

FIG. 17 continues the illustration of the user monitoring portion in display to encourage other users to participate. The live streaming is advertised 1702. The total message count from various attendees are clearly advertised 1704. This allows the event attendees and followers to clearly note the interest level on the event.

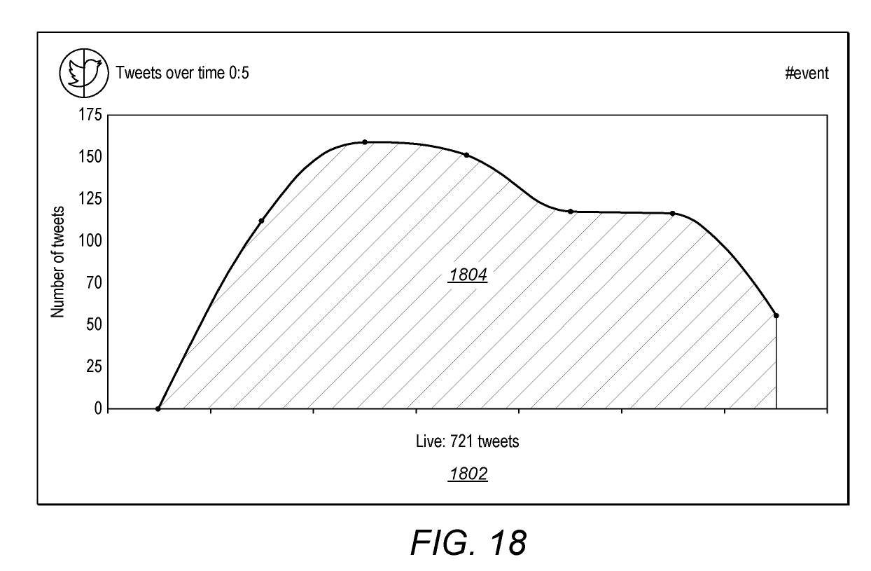

FIG. 18 shows the analytics portion shown real-time in the display. The data shown over time the number of tweets 1802 and the trend 1804 will be useful to gauge the interest level. In addition, the data can be customized for various other social media applications as well. The illustration is shown for Twitter. In addition, it will be appreciated that the various operations, processes, apparatuses and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A computer-implemented method for event management comprising:
receiving data from social media conversations of users attending an event and users who have interest in said event;
storing said data in a redundant knowledge database; and
analyzing said stored data to monitor said conversations specific to said event.

2. The computer-implemented method of claim 1, wherein said analyzing comprises real-time analyzing of said data stored in said redundant knowledge database.

3. The computer-implemented method of claim 1, further comprising providing user access to social media applications over Internet through access tools.

4. The computer-implemented method of claim 1, further comprising providing a consolidated platform of social media applications for users interested in said event.

5. The computer-implemented method of claim 1, further comprising providing an event host client interface to provide access control of said database to general public users.

6. The computer-implemented method of claim 1, further comprising providing a security client interface to provide access control of said database to security users.

7. The computer-implemented method of claim 1, further comprising providing a law enforcement interface to provide access control of said database to law enforcement users.

8. The computer-implemented method of claim 1, further comprising providing a general user client interface to provide access control of said database to general public users.

9. The computer-implemented method of claim 7, wherein said analyzing comprises real-time analyzing and forensic analyzing of said data stored in said redundant knowledge database.

10. A system for event management comprising:
a memory; and
one or more processors coupled to the memory, wherein the memory comprises program instructions to:
receive data from social media conversations of users attending an event and users who have interest in said event;
store said data in a redundant knowledge database; and
analyze said stored data to monitor said conversations specific to said event.

11. The system of claim 10, wherein said data stored in said redundant knowledge database is analyzed in real-time by a data analytics module.

12. The system of claim 10, further comprising a user access to social media applications over Internet through access tools.

13. The system of claim 10, further comprising a consolidated platform of social media applications for users interested in said event.

14. The system of claim 10, further comprising an event host client interface to provide access control of said database to general public users.

15. The system of claim 10, further comprising a security client interface to provide access control of said database to security users.

16. The system of claim 10, further comprising a law enforcement interface to provide access control of said database to law enforcement users.

17. The system of claim 10, further comprising a general user client interface to provide access control of said database to general public users.

18. The system of claim 16, wherein said data stored in said redundant knowledge database is analyzed in real-time by an analytics and forensic module.
